(19) United States
(12) Patent Application Publication
(10) Pub. No.: US 2008/0317549 A1
(43) Pub. Date: Dec. 25, 2008

(54) Vehicle front end module to grille connective arrangement

(75) Inventors: Martin R. Matthews, Troy, MI (US); Vincent A. Harris, Clinton Township, MI (US)

Correspondence Address: WARN, HOFFMANN, MILLER & LALONE, .P.C, PO BOX 70098, ROCHESTER HILLS, MI, 48307, US

(73) Assignee: Magna International Inc., Aurora (CA)

(21) Appl. No.: 11/820,776

(22) Filed: Jun. 20, 2007

(51) Int. Cl. F16B 3/06

(52) U.S. Cl. 403/376

(57) ABSTRACT

An arrangement for connecting a body with a front end module of a vehicle is provided. The arrangement includes in one embodiment a doghouse connected with the front end module. The doghouse has upper, lower and transverse interior borders and an interior engagement surface. A penetrator connected to the body is provided. The penetrator has surfaces closely aligned with the upper, lower and transverse interior borders of the doghouse. The penetrator has a compliant clip for locking engagement with the doghouse interior engagement surface.

### FIELD OF THE INVENTION

The field of the present invention is that of automotive vehicle front end modules and bodies attached to automotive vehicle front end modules.

### BACKGROUND OF THE INVENTION

To increase quality and to lower assembly cost, it is often common to connect various parts into modules which can be quickly assembled when manufacturing an automotive vehicle. Currently in many vehicles, the front of the vehicle in an area closest to the radiator is assembled together into a component typically referred to as a front end module. Connected to the front end module is typically a large molding which provides the front grille of the vehicle. The connection between the front grille and the front end module has to be strong and sturdy to resist squeak due to vehicle vibration. Additionally it is desirable that the grille/front end module connection be hidden from view after the vehicle is assembled. Additionally the connection should be able to be made quickly to minimize assembly time and cost associated therewith. Due to the strength requirements, typically the grille/front end module connections are made with threaded fasteners. It is desirable to provide a non-threaded fastener connection wherein at least a portion of a body or front grille can be connected with the front end module in a quick manner.

### SUMMARY OF THE INVENTION

The present invention provides an arrangement for connecting a body, such as a front grille, with a front end module of a vehicle. In one embodiment the arrangement includes a doghouse connected with a front end module. The doghouse has upper, lower and transverse interior borders and an interior engagement surface. A penetrator is connected with the front grille. The penetrator has surfaces closely aligned with upper, lower and transverse interior borders of the doghouse. The penetrator has a compliant clip for locking engagement with the doghouse interior engagement surface. Due to the close alignment of the penetrator with the interior borders of the doghouse, transverse and vertical loads are largely absorbed by the interface between the penetrator and the doghouse and the clip engagement with the locking surface is largely unaffected by such forces.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a perspective view of the connective arrangement of the present invention showing a front grille attached to a front end module looking towards a center line of the vehicle;

FIG. 2 is a perspective view similar to that of FIG. 1 looking away from a center line of the vehicle;

FIG. 3 is a rear perspective view illustrating a front grille connected penetrator being inserted within a doghouse connected with the front end module;

FIG. 4 is a perspective view similar to that of FIG. 2 illustrating the penetrator and doghouse of the present invention before insertion of the penetrator into the doghouse;

FIG. 5 is a perspective view illustrating the front grille and penetrator from a side opposite the front end module;

FIG. 6 is an enlarged perspective view of the front grille with its penetrator shown in a direction generally opposite that of FIG. 5;

FIG. 7 is a perspective side view of the penetrator shown in FIG. 6 illustrating a side of the penetrator opposite a compliant clip;

FIG. 8 is a section view taken along line 8-8 of FIG. 6;

FIG. 9 is a section view taken along line 9-9 of FIG. 3;

FIG. 10 is a section view taken along line 10-10 of FIG. 2.

### DETAILED DESCRIPTION OF THE PREFERRED EMBODIMENTS

The following description of the preferred embodiment(s) is merely exemplary in nature and is in no way intended to limit the invention, its application, or uses.

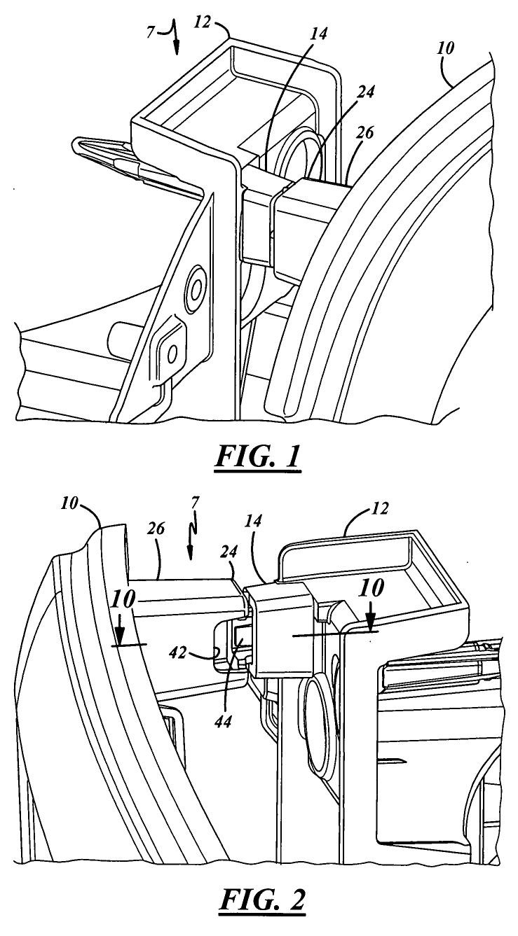

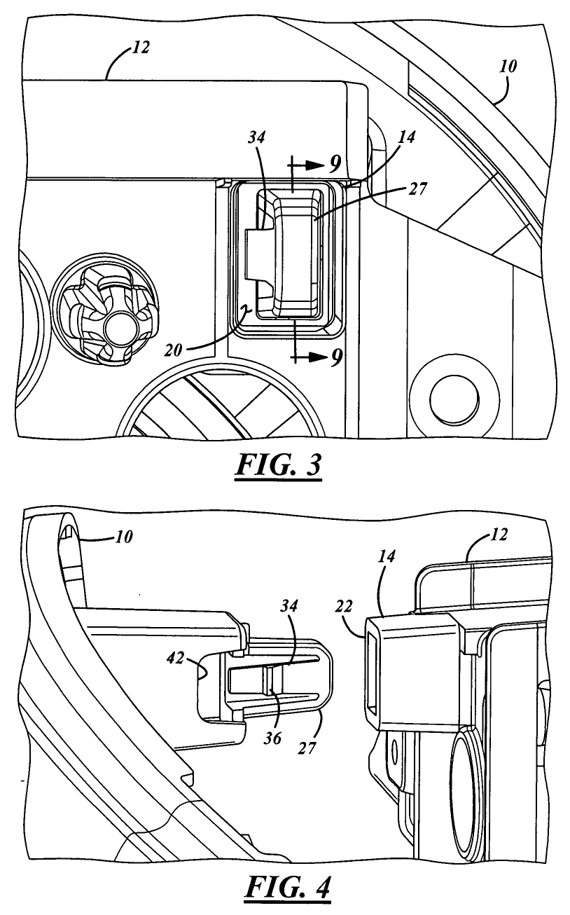

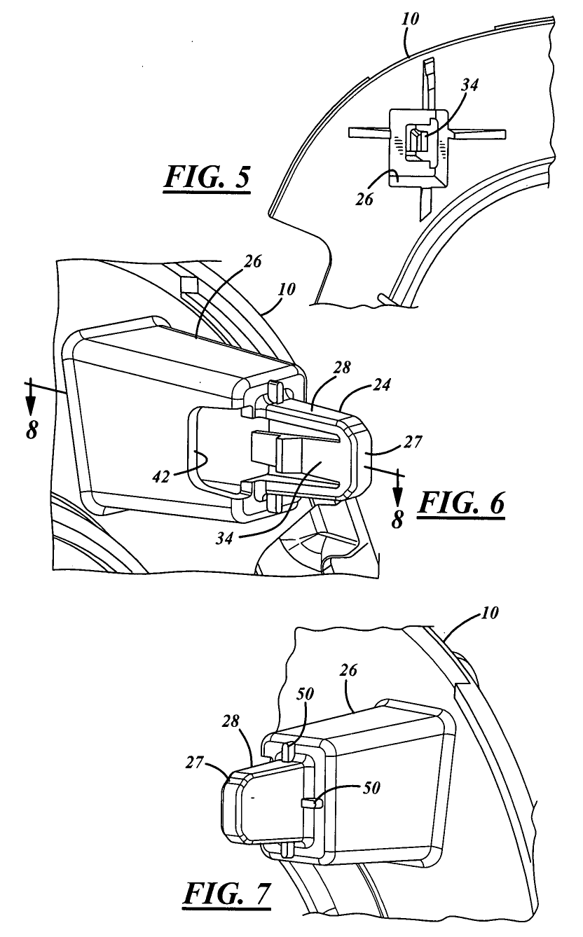

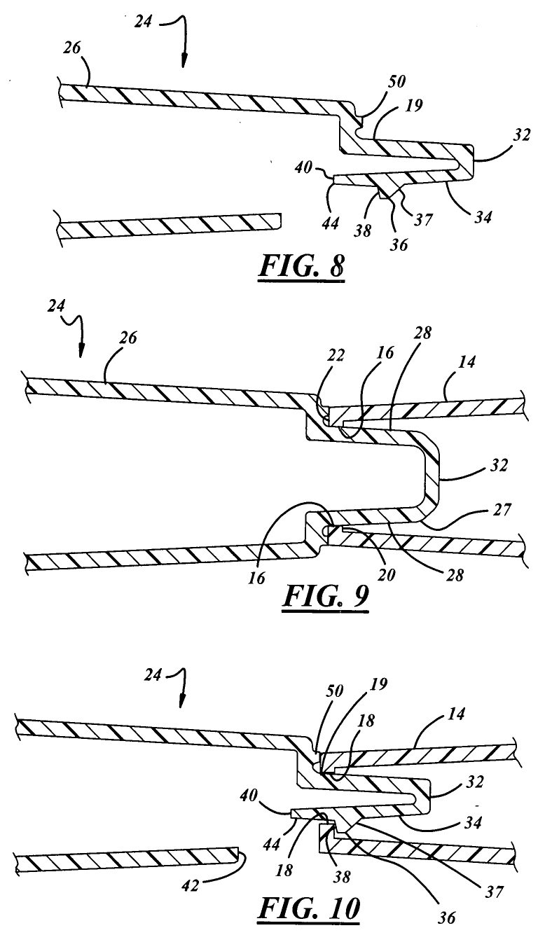

Referring to the FIGS. 1-10, the present invention provides an arrangement 7 for connecting a body such as a molded polymer front grille 10 assembly to a vehicle front end module 12. Projecting outward and forward from the front end module 12 is a doghouse 14. The doghouse 14 is typically integral with the front end module 12 and is typically fabricated from a thermal plastic material. The doghouse 14 typically has interior upper and lower borders 16. The doghouse has transverse interior borders 18 which are typically approximately 50% less in length apart than the vertical borders 16. The doghouse interior borders 16 and 18 typically are quadrangular in shape. The doghouse also has an interior engagement surface 20. As shown, the doghouse interior engagement surface 20 is generally adjacent a doghouse forward end 22.

The connecting arrangement 7 also includes a penetrator 24. The penetrator 24 projects outwardly from and is integrally connected to the grille 10. The penetrator is typically fabricated from an acrylic-styrene-acrylonitrite or acrylonitrite butadiene styrene plastic. The penetrator 24 has a generally hollow base body 26. Projecting from the base body 26 is a stud body 27. The stud body 27 has upper and lower surfaces 28. The upper and lower surfaces 28 are tapered towards one another at approximately a 3 degree angle causing them to have an aligning locking wedge fit with the upper and lower borders 16 of the doghouse 14. Projecting cantileverly from a forward end 32 of the penetrator is a compliant clip 34. The clip 34 has a barb or locking tab 36. The locking tab 36 has a cam surface 37. The locking tab 36 has an angled rearward or locking edge 38. The locking edge 38 is provided for engagement with the interior engagement surface 20. Upon insertion of the stud body 27 into the doghouse 14, the cam surface 37 contacts the doghouse forward end 22 to urge the clip 34 inward. The locking edge 38 will then engage the interior engagement surface 20. The locking edge 38 imparts a lateral force upon the interior surface 20 to cause the clip 34 to spread open up if the grille 10 is pulled forward. Therefore, the clip 34 is self-engaging upon a forward removal pull on the grille 10.

Adjacent an extreme end 40 of the clip and the penetrator base body 26 is an open window referred to as the service window 42. The service window 42 is typically positioned on the inboard side of the penetrator 24 and allows a tool or instrument to hit an exposed extending portion or release arm 44 (extending past the doghouse forward end 22) of the clip to release the clip from the doghouse 14 and therefore release the grille 10 from the front end module 12.

The penetrator 24 has a series of adjustment pads 50 to allow custom fitting of the grille 10 in the fore and aft direction in its relationship with the front end module 12. When fitted within the doghouse the penetrator stud body 27 also has transverse surfaces 19 that are closely aligned to the transverse interior borders 18 of the doghouse. Accordingly the transverse and vertical relative motion between the grille 10 and front end module 12 is absorbed by the penetrator stud body 27 and doghouse 14 and has little or no effect upon the locking engagement of the clip 34 with the interior engagement surface 20.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. An arrangement for connecting a body with a front end module of a vehicle, said arrangement comprising:
a doghouse connected with one of said body and said front end module, said doghouse having upper, lower and transverse interior borders, said doghouse having an interior engagement surface; and
a penetrator connected to said other one of said body and said front end module, said penetrator having surfaces closely aligned with said upper, lower and transverse interior borders of said doghouse, and said penetrator having a compliant clip for locking engagement with said doghouse interior engagement surface.

2. An arrangement as described in claim 1 wherein said doghouse is on said front end module.

3. An arrangement as described in claim 1 wherein said doghouse projects outwardly from one of said body and said front end module.

4. An arrangement as described in claim 1 wherein said penetrator projects outwardly from said other of said body and said front end module.

5. An arrangement as described in claim 1 wherein said body is a front grille.

6. An arrangement as described in claim 1 wherein said doghouse interior engagement surface is generally adjacent a forward end of said doghouse.

7. An arrangement as described as in claim 1 wherein said doghouse interior borders are generally shaped as a quadrangle.

8. An arrangement as described in claim 1 wherein said clip is cantileverly supported from said penetrator.

9. A clip as described in claim 8 wherein said clip is connected to said penetrator generally adjacent in extreme end said penetrator.

10. An arrangement as described in claim 1 having a service window to allow access to release said clip from doghouse engagement surface.

11. An arrangement as described in claim 10 wherein said service window is positioned between said body and said front end module.

12. An arrangement as described in claim 10 wherein said clip has a release arm.

13. An arrangement as described in claim 1 wherein said clip is configured to be self engaging when attempting to remove said body from said front end module.

14. An arrangement as described in claim 1 further including adjustment pads between said penetrator and said body to adjust the position of said body with respect to said front end module.

15. An arrangement as described in claim 1 wherein said body material is a thermal plastic.

16. An arrangement as described in claim 1 wherein said front end module is thermal plastic.

17. An arrangement for connecting a grille with a front end module of a vehicle, said arrangement comprising:
a doghouse projecting from said front end module, said doghouse having a generally quadrangular interior with upper, lower and transverse interior borders, said doghouse having an interior engagement surface; and
a penetrator projecting from said grille, said penetrator having surfaces closely aligned with said interior borders of said doghouse, and said penetrator having a cantilevered compliant clip for locking engagement with said doghouse engagement surface.

18. An arrangement as described in claim 17 wherein said front end module and said grille are thermal plastics and said doghouse is integrally molded with said front end module and said penetrator is integrally molded with said grille.

19. An arrangement as described in claim 1 wherein said clip is configured to be self engaging when attempting to remove said body from said front end module.

20. An arrangement for connecting a grille with a front end module of a vehicle, said arrangement comprising:
an integrally molded doghouse projecting from said front end module, said doghouse having a generally quadrangular interior with upper, lower and transverse interior borders, said doghouse having an interior engagement surface; and
an integrally molded penetrator projecting from said grille, said penetrator having surfaces closely aligned with said interior borders of said doghouse, and said penetrator having a cantilevered compliant clip for locking engagement with said doghouse interior engagement surface, said clip having a release arm for releasing said clip and said penetrator having a base with a release widow exposing said release arm.
